(19) United States
(12) Patent Application Publication
(10) Pub. No.: US 2011/0299597 A1
(43) Pub. Date: Dec. 8, 2011

(54) IMAGE PROCESSING METHOD USING MOTION ESTIMATION AND IMAGE PROCESSING APPARATUS

(75) Inventors: Volker FREIBURG, Stuttgart (DE); Altfried DILLY, Stuttgart (DE); Yalcin INCESU, Heidelberg (DE); Oliver ERDLER, Ostfildern (DE)

(73) Assignee: SONY CORPORATION, Tokyo (JP)

(21) Appl. No.: 13/105,260

(22) Filed: May 11, 2011

(30) Foreign Application Priority Data
Jun. 7, 2010 (EP) 10 005 884.1

(51) Int. Cl. H04N 7/26

(52) U.S. Cl. 375/240.16; 375/E07.125

(57) ABSTRACT

From first and second image data descriptive for first and second pictures captured in a first temporal distance to each other, a global motion estimator unit (110) estimates a global motion vector, which is descriptive for sign and amount of a global displacement of image portions that move with respect to a first axis both when the move at the same speed and when they move at different velocities. The global motion vector improves estimation of fast moving objects. The global motion vector estimation may rely on the evaluation of a plurality of one-dimensional profiles.

Embodiments of the invention refer to an image processing apparatus including a motion estimator unit and to a frame rate conversion apparatus. Other embodiments refer to an image processing method comprising determination of a motion vector and to a frame rate conversion method.

Pixel-motion analysis is used for implementing a variety of temporal functions in video streams such as de-interlacing, frame rate conversion, image coding, and multi-frame noise reduction. Motion analysis attempts to identify, where each pixel that represents a point on a potentially moving object might be found in a subsequent or interleaved frame. Motion analysis determines motion vectors assigned to single pixels or pixel groups and indicates, where each pixel has moved from or will move to from frame to frame.

The object underlying the embodiments of the present invention is to improve the performance of motion estimation. This object is achieved with the subject-matters of the independent claims. Further embodiments are specified in the dependent claims, respectively.

Details of the invention will become more apparent from the following description of the embodiments in connection with the accompanying drawings. Features of the various embodiments may be combined unless they exclude each other.

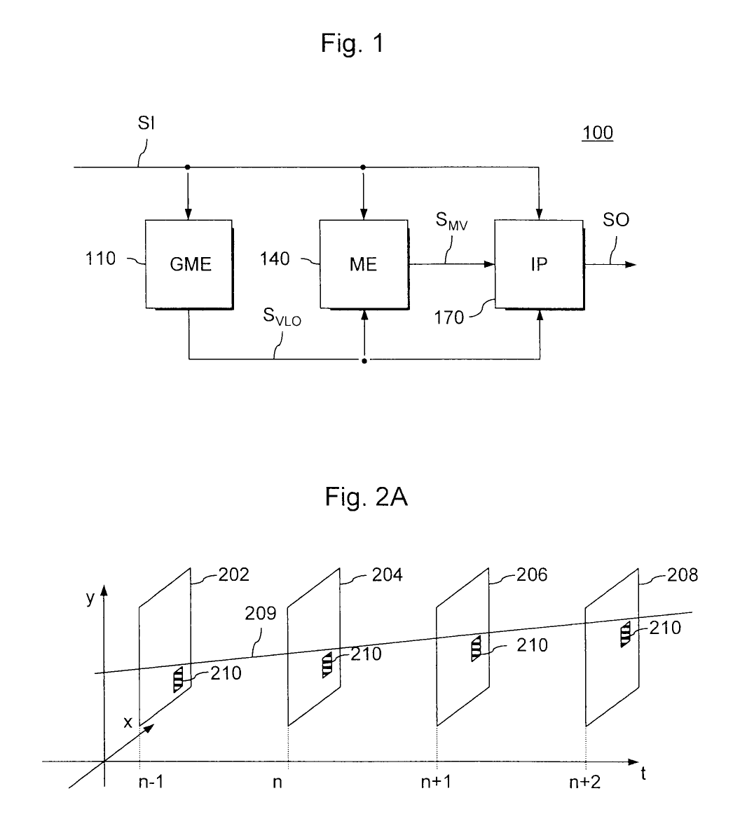

FIG. 1 is a simplified block diagram illustrating an image processing apparatus comprising a global motion estimator unit in accordance with an embodiment referring to motion vector estimation.

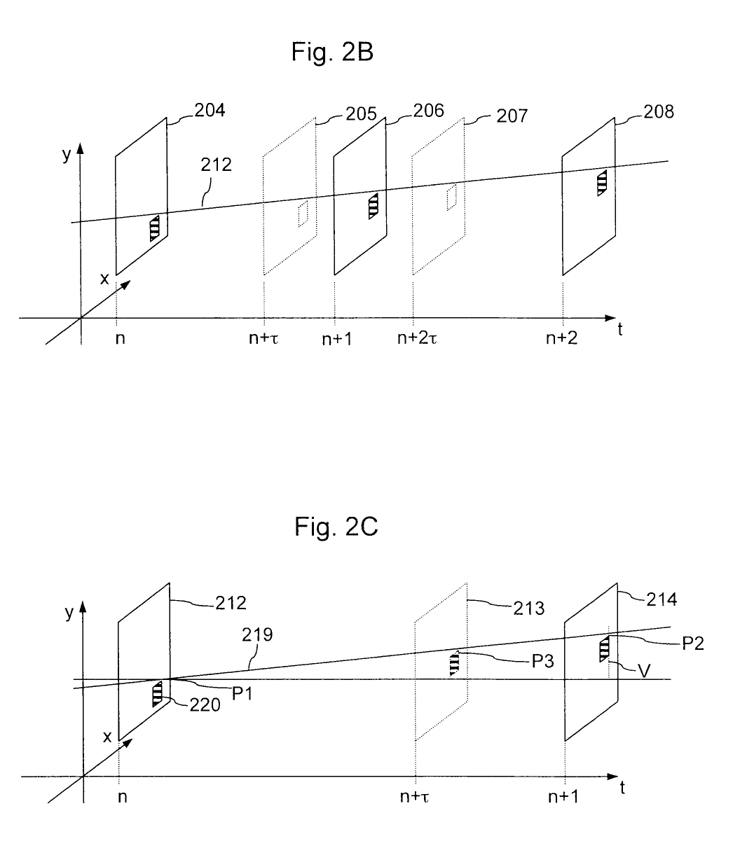

FIG. 2A is a schematic diagram showing four successive picture frames with a moving object.

FIG. 2B is a diagram illustrating two interleaved frames inserted in a stream of frames for describing principles of frame rate conversion and for clarifying effects of embodiments of the invention.

FIG. 2C is a schematic diagram showing a detail of FIG. 2B.

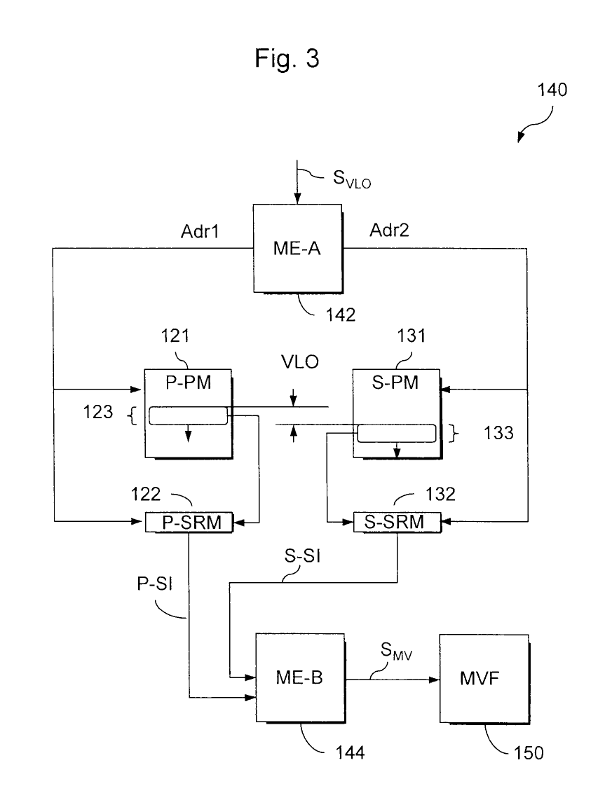

FIG. 3 is a schematic block diagram illustrating a motion vector estimator unit using two cache memories and a global motion vector in accordance with an embodiment of the invention.

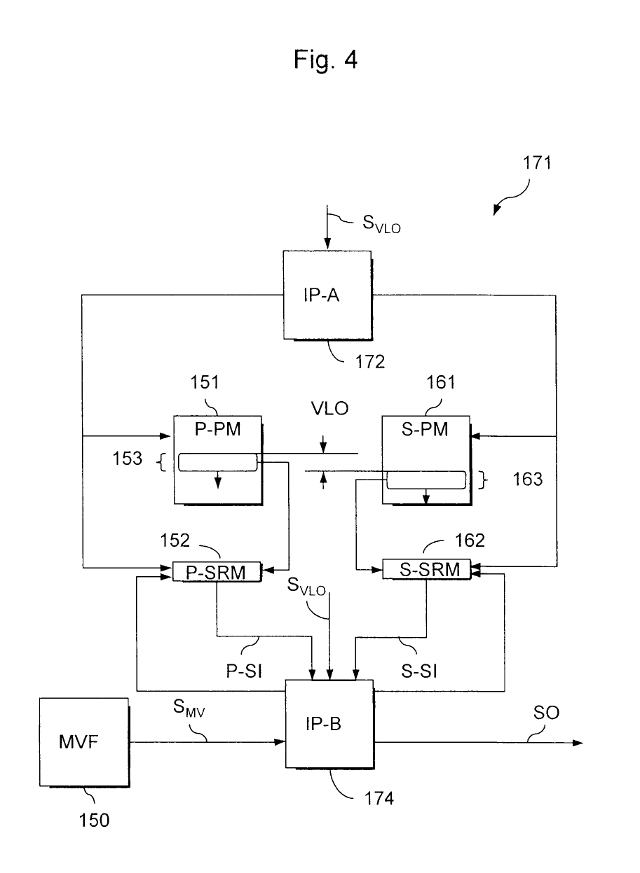

FIG. 4 is a simplified block diagram illustrating an interpolation unit using two cache memories and a global motion vector in accordance with an embodiment referring to frame rate conversion.

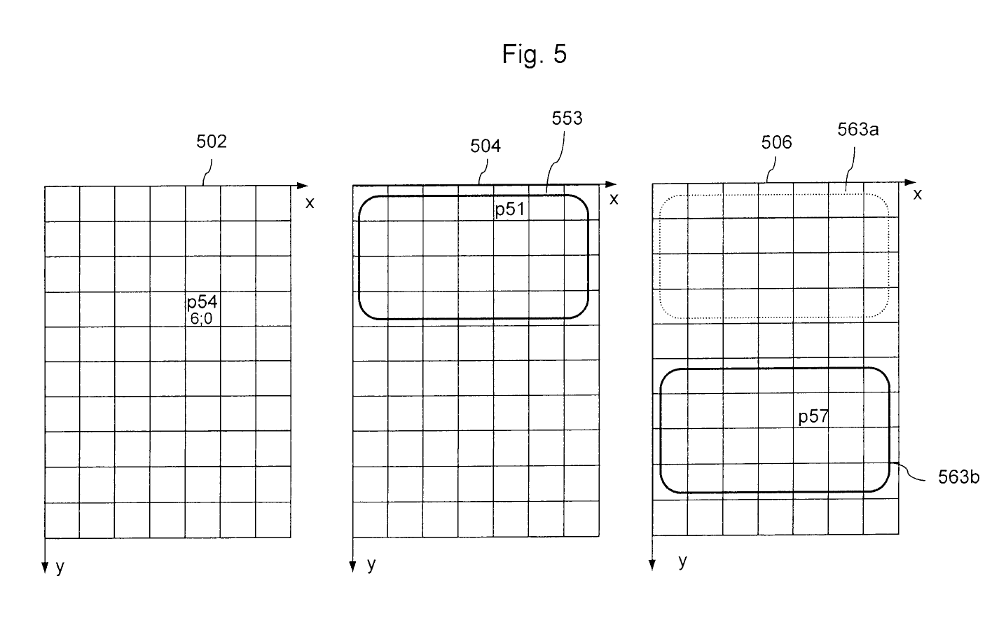

FIG. 5 is a schematic diagram showing a simplified motion vector field and a relationship between two address windows for cache memories assigned to two picture memories for illustrating the mode of operation of a motion estimator unit in accordance with an embodiment of the invention.

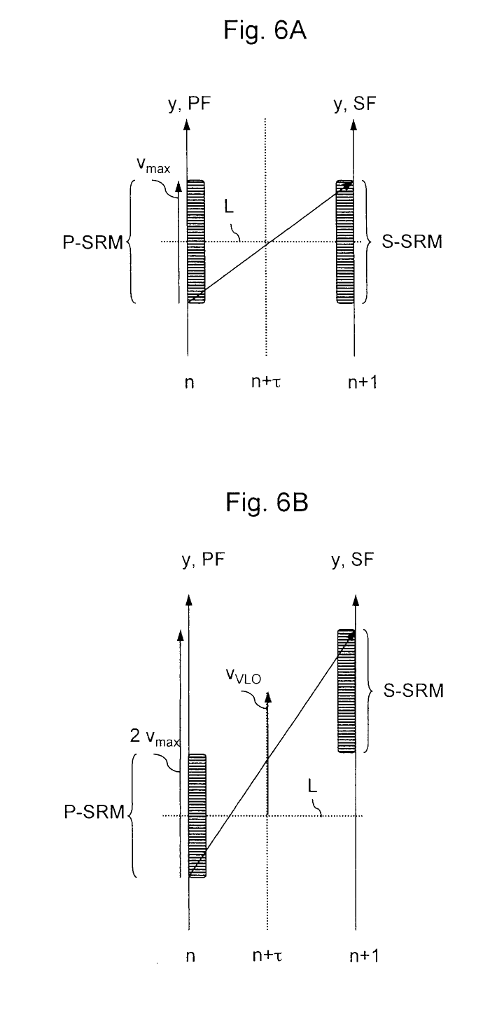

FIG. 6A is a diagram for illustrating the mode of operation of an image processing apparatus according to an embodiment in case a global motion vector is equal to zero.

FIG. 6B is a diagram for illustrating the mode of operation of an image processing apparatus according to the embodiment of FIG. 6A in case the global motion vector has a maximum value.

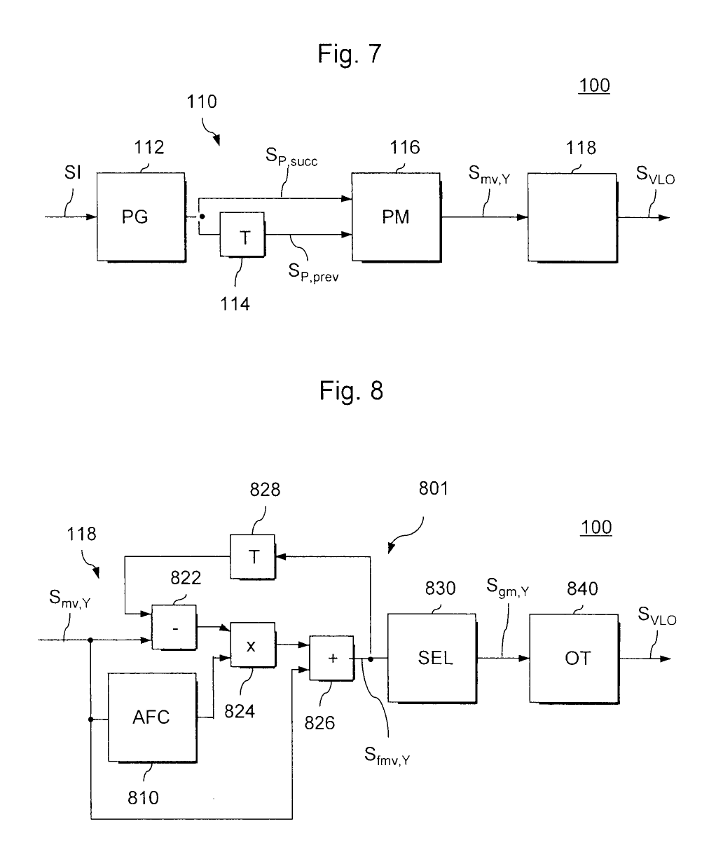

FIG. 7 is a simplified block diagram illustrating details of a global motion estimator unit in accordance with another embodiment of the invention.

FIG. 8 is a schematic block diagram illustrating details of the global motion estimator unit of FIG. 7 in accordance with an embodiment referring to a filtering of shift values of one-dimensional line profiles.

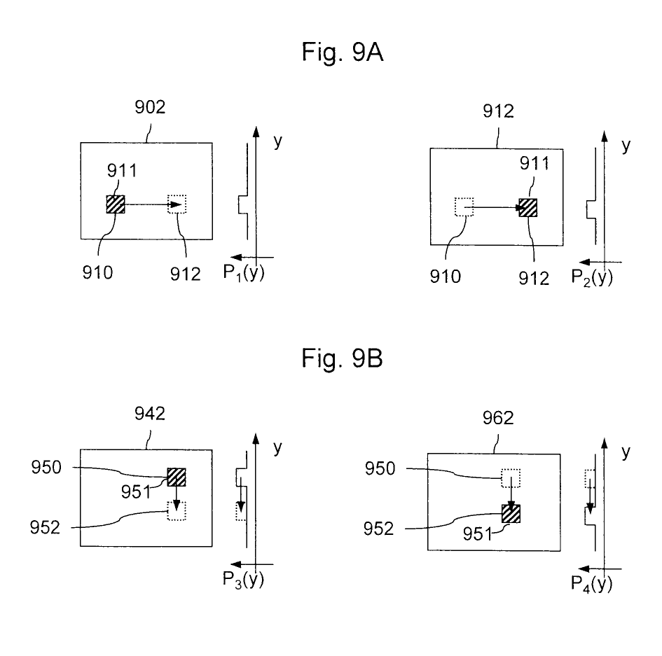

FIG. 9A contains two diagrams illustrating the effect of a horizontally moving object on a vertical line profile for illustrating details of an image processing method according to an embodiment.

FIG. 9B contains two diagrams for illustrating the effect of a vertically moving object on a vertical line profile for illustrating details of an image processing method according to an embodiment.

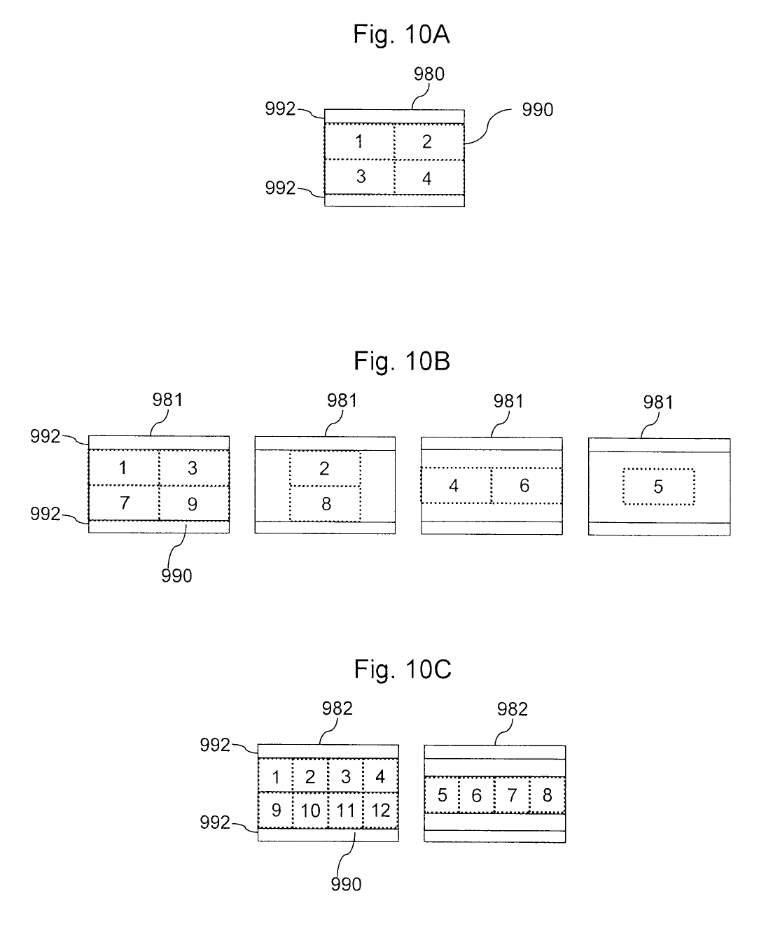

FIG. 10A is a simplified diagram illustrating an apportionment of an image frame into four picture portions for determining line profiles in accordance with an embodiment referring to details of a global motion estimator unit according to an embodiment.

FIG. 10B is a simplified diagram illustrating an apportionment of an image frame into nine picture portions for determining line profiles in accordance with an embodiment referring to details of a global motion estimator unit according to another embodiment.

FIG. 10C is a simplified diagram illustrating an apportionment of an image frame into twelve picture portions for determining line profiles in accordance with another embodiment.

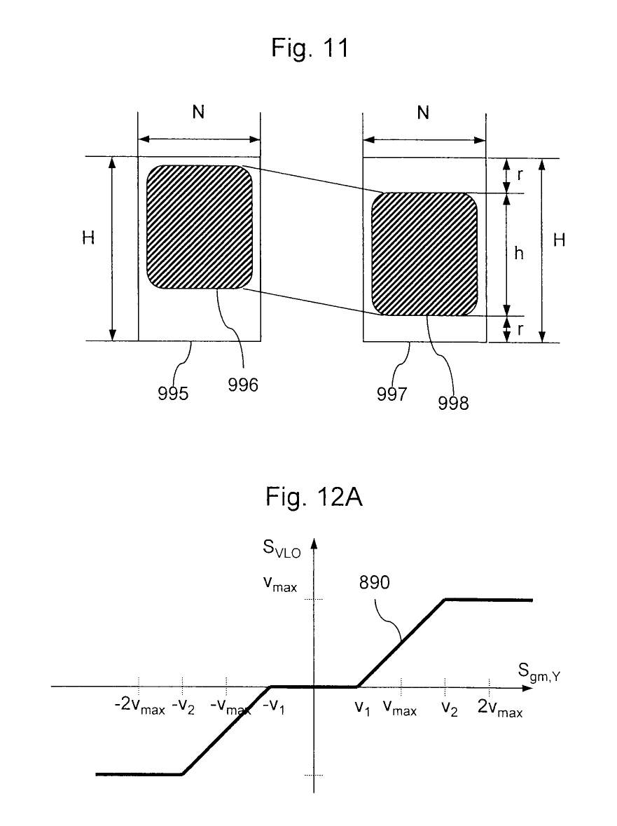

FIG. 11 is a schematic diagram for illustrating details of the mode of operation of a profile matching unit in accordance with embodiments referring to a global motion estimator unit.

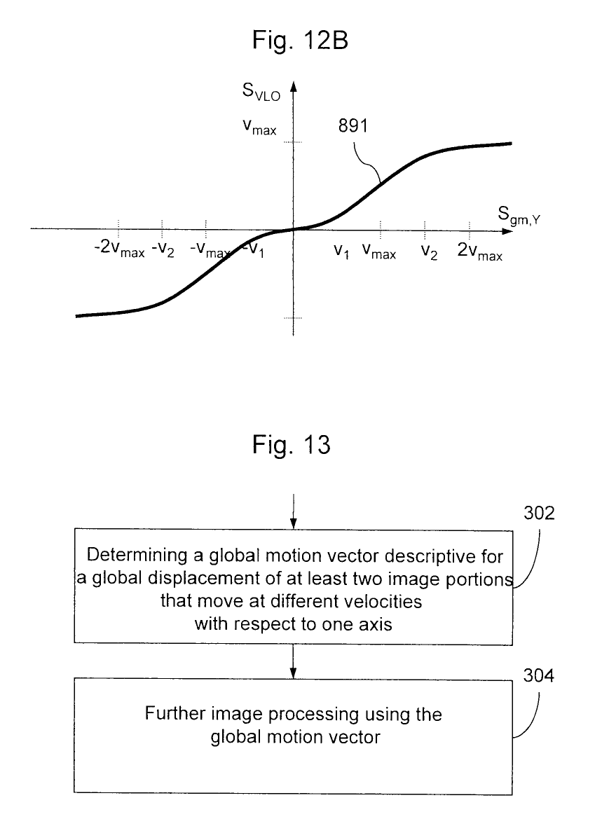

FIG. 12A is a diagram illustrating a mapping rule for obtaining an address offset from a global motion vector in accordance with an embodiment referring to details of an image processing apparatus using a global motion vector.

FIG. 12B is a diagram illustrating another mapping rule for obtaining an address offset from a global motion vector in accordance with another embodiment.

FIG. 13 is a simplified flowchart for illustrating an image processing method in accordance with an embodiment referring to the use of a global motion vector.

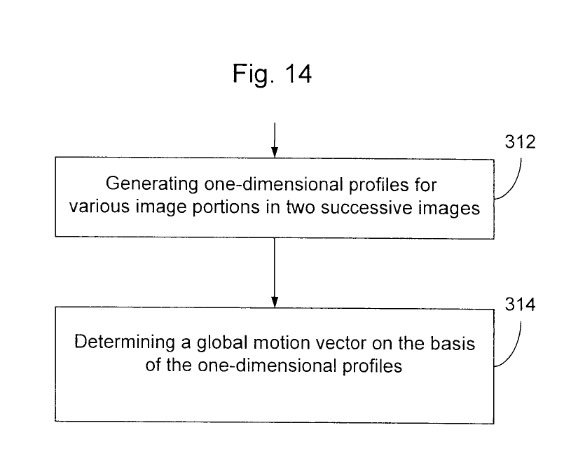

FIG. 14 is a simplified flowchart for illustrating an image processing method in accordance with an embodiment referring to the generation of global motion vector.

FIG. 1 refers to an image processing apparatus 100 comprising a global motion estimator unit 110. From first and second image data describing a first and a second picture captured in a first temporal distance to each other, the global motion estimator unit 110 determines a global motion vector which is descriptive for sign and amount of a global displacement of at least two image portions that move with respect to one first axis both when the image portions move at the same and when they move at different velocities.

For example, the global motion vector represents a weighted mean velocity of all image objects moving with respect to the first axis in relation to a non-moving background. The first and second pictures may be subsequent frames of a video stream SI. Determination of the global motion vector may be repeated for each pair of successive frames.

In accordance with an embodiment, the moving image portions correspond to objects or portions of objects. According to another embodiment, the moving image portions correspond to predefined windows or picture sections of a frame, wherein a velocity assigned to the respective picture section results from a comparison of corresponding pixel values in corresponding picture sections of two successive frames. For example, sums of pixel values of corresponding lines or columns in corresponding picture sections of two successive frames may be compared with each other to determine a parameter characterizing a velocity within a picture section. In the latter case, the velocities are not assigned to objects but characterize the sum of movements within one of the picture sections respectively.

The global motion vector generalizes different movements of a plurality of moving objects along the same axis. For example, when a plurality of different objects move with approximately the same speed in the same direction, the global motion vector in substance represents this common velocity. Otherwise, when two objects of approximately the same size move with the same velocity in opposing directions, the global motion vector tends to become zero. The global motion estimator unit 110 may output a value representing the global motion vector in units referring exclusively to frame parameters. In accordance with other embodiments, the global motion vector unit 110 combines the global motion vector with application or hardware specific values. For example, the global motion estimator unit 110 outputs an address offset S_{VLO} used for loading cache memories.

In accordance with the embodiment illustrated in FIG. 1, the image processing apparatus further comprises a motion vector estimator unit 140. On the basis of the global motion vector determined in the global motion estimator unit 110 and on the first and second image data, the motion vector estimator unit 140 determines a motion vector field that describes for each image portion a local displacement along the first axis and a second axis perpendicular to the first axis.

The first axis may be the vertical picture axis and the second axis may be the horizontal picture axis, by way of example. The motion vector field may assign a motion vector S_{MV} to each pixel of an image or to pixel groups which have been identified as belonging to the same moving object. The motion vectors S_{MV} may be provided as absolute values or as relative values referring, for example, to the address offset. The motion vectors S_{MV} may be temporarily buffered in a motion vector field memory.

In accordance with an embodiment, the motion vectors S_{MV} and a value derived from the global motion vector determined in the global motion estimator unit 110 may be used in an image processing unit 170.

The image processing unit 170 may be, by way of example, a video analyzing unit for determining and classifying moving objects in the video stream S1, for example within the framework of surveillance tasks and monitoring systems. According to other examples, the image processing unit 170 is an image coding device for image data compression.

According to a further embodiment, the image processing unit 170 is an interpolation unit configured to generate third image data descriptive for a third image on the basis of the first and second image data, the motion vectors S_{MV}, and a value derived from the global motion vector and to output a sequence of third images as output video stream S0. The interpolation unit obtains a pixel value of a pixel of the third image by filtering the pixel value of a first pixel or pixel values of a group of pixels of the first image data with a pixel value of one second pixel or with pixel values of a group of pixels of the second image data. The first and second pixels are identified on the basis of the position of the corresponding pixel in the third image, one or more entries in the motion vector field associated with that pixel or a group of entries in the motion vector field associated with a plurality of pixels in the neighborhood of that pixel, the global motion vector and a ratio between the first temporal distance between the first and second picture and a second temporal distance between the first and third picture or between the second and third picture.

An embodiment of the invention refers to a frame rate converter comprising the global motion estimator unit 110, the motion estimator unit 140 and an interpolation unit as the image processing unit 170 as illustrated in FIG. 1. Frame rate conversion is applied where a source, for example an image pick-up device, an image processing device or a storage device, provides the picture data of a video stream in a first frame rate and a sink, for example a display device, another image processing device or another storage device requires a higher or a lower second frame rate. For example, the frame rate may be increased for improving the perception quality of a video stream or during transitions between different video standards.

FIG. 2A shows a sequence of four consecutive frames 202, 204, 206, 208 representing a section of a video stream. Each pair of consecutive frames represents pictures captured in a first temporal distance to each other. The frames 202, 204, 206, 208 are orientated to a horizontal x-axis and a vertical y-axis. A moving object 210 changes its position from frame to frame 202, 204, 206, 208 and performs a linear movement along the y-axis, by way of example.

FIG. 2B refers to a frame rate conversion where the frame rate is increased by about 50%. Using picture data describing the frames 204, 206, 208 the motion of the moving object 210 is estimated and from the estimated motion and the picture data describing the adjacent frames 204, 206, 208 the positions of the moving object 210 at n+τ and n+2τ are estimated. On the basis of the estimated position of the moving object 210 the picture data for two additional frames 205 and 207 is generated and inserted into the video stream while frame 206 may be deleted.

FIG. 2C depicts generation and insertion of an additional frame 213 between a first frame 212 and a second frame 214 in more detail. The first and second frames 212, 214 contain a moving foreground object 220 in front of a still background. In the second frame 214 the moving object 220 is displaced with respect to its position in the first frame 212. The vector v describes the displacement along the y-axis. For properly interpolating the intermediate frame 213 at time n+τ with 0<τ<1, the interpolation unit scales the vector v by the factor τ to find the interpolated position of the moving object 220. The line 219 represents the assumed movement of the moving object 220.

For generating the additional frame 213, the interpolator unit accesses picture memories containing the picture data of the first frame 212 and the second frame 214. The line 219 represents corresponding pixel positions P1, P2 in the previous and next frame 212, 214 at time indices n and n+1, respectively, where the image parts at those positions P1, P2 are used in a filtering process to produce an interpolated image part at the corresponding pixel in the inserted frame 213. In other words, when the interpolation unit calculates the pixel values of the image part at position P3, it accesses a motion vector assigned to the image part at P3. Further, fractions τ and 1-τ of displacement vector v are used to access the picture data at time index n and n+1, respectively.

However, a limiting factor in the design of a such a motion estimation system is a supported maximum length of the motion vector to address and read the picture data locations in the frames at times n and n+1, respectively. Depending on the system architecture, the length of the motion vector is constrained with regard to at least one of the frame dimensions.

For example, the inserted frame 213 may be generated line-by-line from the top left corner of the picture to the bottom right. Each pixel of the inserted frame 213 is assigned to a previously computed motion vector, which is used to address corresponding pixels in the first and second frames 212, 214 for performing the interpolation. A fast and free random access into the memory containing the first and second picture data is required. However, a fast and free random access is in conflict with, for example, DRAM (dynamic random access memories) topology, because DRAMs, which are typically used as picture memory, provide best data throughput only when the DRAM contents is addressed in a linear fashion as used in a scan line-based processing unit.

Therefore typically a specialized cache memory is provided in another memory technology that supports fast random access. According to an example, the cache memory is realized as a search range memory in SRAM (static random access memory) technology. Since an SRAM requires more system resources, the memory cache typically does not contain the full image frame. Instead, during processing of the full image frame, with each new scan line, the first line at an upper boarder of a sliding address window is discarded in the SRAM and replaced with the new line at the lower boarder of the sliding address window such that the address window is moved line-by-line down the picture memory in an FIFO (first-in-first-out)-manner.

FIG. 3 refers to an embodiment wherein an address offset S_{VLO} derived from the global motion vector is used in a motion vector estimator unit 140. A first sub-unit 142 of the motion vector estimator unit 140 loads a first subset (window) 123 of a first image data from a first picture memory 121 into a first cache memory 122 using address Adr1. In addition, the first sub-unit 142 loads a second subset 133 of the second image data from a second picture memory 131 into a second cache memory 132 using a second address Adr2. The cache memories 122, 132 have a faster random access time than the picture memories 121, 131. In accordance with an embodiment, the cache memories 122, 132 are SRAMs, whereas the picture memories 121, 131 are DRAMs. The first and second subsets 123, 133 correspond to pixels displaced to each other along the first axis by a displacement derived from the global motion vector.

The displacement corresponds to a specific memory address offset VLO between the first address Adr1 and the second address Adr2. The specific memory address offset VLO is derived from the address offsets S_{VLO} provided by the global motion estimator unit 110 of FIG. 1. The second sub-unit 144 of the motion vector estimator unit 140 accesses the first and second cache memories 122, 132 delivering first image data P-SI from a previous picture and second image data S-SI from a successive image in order to derive motion vectors Sₘᵥ which may be stored in a motion vector field memory 150.

Since the windows loaded in the cache memories 122, 132 are offset to each other, the motion vector estimator unit 140 can handle faster objects moving along the vertical picture direction. The embodiment takes advantage of the fact that in real life video such situations dominate, where, when the video shows a fast object moving in a first direction, there are rarely fast objects moving in the opposite direction. In addition, typically a fast moving object attracts attention such that the perception of the video is improved when the perception of the fast moving object is improved.

FIG. 4 refers to an interpolation unit 171 of a frame rate converter. A first sub-unit 172 loads a third subset 153 of the first image data from a third picture memory 151 into a third cache memory 152 and a fourth subset 163 of the second image data from a fourth picture memory 161 into a fourth cache memory 162. The cache memories 152, 162 have a faster random access time than the picture memories 151, 161. The third and fourth subsets 153, 163 represent pixels displaced versus each other along the first axis by a displacement derived from the global motion vector. A second sub-unit 174 addresses the first and second cache memories 152, 162 in dependence on motion vectors S_{MV} received from a motion vector field memory 150 and assigned to the respective output pixel or pixel group. In other words, the first sub-unit 172 loads the cache memories 152, 162 wherein during a read access of the picture memories 151, 161 it applies an address offset VLO that is derived from the current global motion vector. The subsets 153, 163 or “windows” being copied in the search range memory for the previous image may be shifted up or down and that for the successive image may be convertly shifted down and up if a predetermined vertical motion is observable in the image sequence as, for example, with regard to vertical camera pans or rocket launches.

The embodiments as illustrated in FIGS. 3 and 4 may be combined with each other in various ways. For example, the interpolation unit 171 and the motion vector estimator 140 may share the same picture memories 121 or 151, and 131 or 161, such that the motion vector estimator unit 140 and the interpolation unit 171 share the same picture memories. Once the picture memories have been loaded, both the motion vectors Sₘᵥ are derived therefrom and frame rate conversion is carried out. According to another embodiment, they use different picture memories, wherein the third and fourth picture memory 151, 161 may contain other picture data of a video stream than the first and second picture memories 121, 131 such that a first stage comprising the motion vector estimator unit 140 prepares the motion vectors used later in a second stage including the interpolator unit 171.

According to an embodiment, the cache memories 152, 162 assigned to the interpolation unit 171 have the same size and access configuration as the cache memories 122, 132 assigned to the motion vector estimator unit 140. In accordance with another embodiment, the cache memories 122, 132 assigned to the motion vector estimator unit 140 have a smaller address space than the cache memories 152, 162 assigned to the interpolation unit 171. Such embodiments may ensure that the motion vector estimator unit 140 does not generate motion vectors referring to invalid addresses when the interpolation unit 171 tries to access the third and fourth cache memories 152, 162. If the cache memories have identical size, the interpolation unit 171 can access all portions in the search range memory such that the search range memory is effectively used. According to another embodiment, a common address offset is evaluated for the same time instance and is used in both the motion vector estimation unit and the interpolation unit.

FIG. 5 shows in a simplified form the contents of a motion vector field 502, a first picture memory 504, and a second picture memory 506 with ten lines extending along the x-axis and seven columns extending along the y-axis, respectively. Each entry in the motion vector field 502 may be accessible by the column index and the line index and represents a first value describing a displacement along the y-axis and a second value describing a displacement along the x-axis. For simplification, it is assumed that the first value directly represents a line offset. According to other embodiments, the entries may represent a relative reference with respect to an address offset of the cache memories.

When the interpolation unit tries to evaluate pixel p54 of an estimated frame to be inserted on half way between two other frames (τ=0.5) it may access inter alia the entry p54 of the motion vector field 502. In accordance with the access scheme as described with reference to FIG. 2C with τ=0.5, the interpolation unit tries to access entry p51 in the first picture memory 504 and entry p57 in the second picture memory 506. The window 553 represents the contents of the first cache memory assigned to the first picture memory 504 and covers the pixel assigned to entry p51 in the first picture memory 504. However, if the second window in the second pixel memory 506 were to be positioned over the same search range as it is the case for search window 563a, the interpolation unit would not be able to access entry p57 for the corresponding pixel in the second picture memory 504. However, if for the motion vector field 502 a global motion vector is available, a vertical line offset may be applied when the contents of the second picture memory 506 is transferred into the second cache memory. If the vertical line offset is greater or equal 3, the interpolation unit can access the entry p57 as it is the case for search window 563b.

Basically, the global motion vector is zero or approximately zero, when motion in the image is very inhomogeneous, wherein the pictures comprise a plurality of moving objects moving at different velocities in both opposing vertical directions. When the motion picture is homogeneous and all moving objects move more or less at the same velocity in the same direction, the line offset in substance corresponds to a pixel displacement resulting from the object velocity. In substance, if all moving objects move towards the same direction, the vertical line offset may correspond to a weighted mean value of the object velocities.

FIG. 6A refers to a situation where the global motion vector is zero. A search range memory P-SRM for the previous image, which corresponds to the first picture at time n and a search range memory S-SRM for the successive image corresponding to the picture at time n+1 refer to the same pixel addresses. Both search range memories are symmetrically centered around a specific output line L for which the interpolation unit currently calculates the pixel values of the interpolated frame. Referring back to FIG. 2C, with τ=0.5, the maximum object velocity vₘₐₓ along the y-axis which the interpolation unit can handle, corresponds to the number of lines contained in the search range memories P-SRM, S-SRM. If the displacement for a moving object between two subsequent images along the y-axis corresponds to a line number greater than the line depth of the search range memories, the interpolation unit cannot correctly interpolate the position of the moving object in the interpolated frame and perceptible image degradation occurs.

FIG. 6B refers to a situation where the vertical line offset determined by the global motion estimator unit is equal to the number of lines contained in the search range memories P-SRM, S-SRM. The maximum vertical motion, which the interpolation unit now can handle, is the sum of a vector defining the search range memory size and the vertical line offset vector v_{VLO}. In accordance with an embodiment, the vertical line offset vector v_{VLo} is not limited to a certain value. In accordance with another embodiment, the vertical line offset is equal to or lower than the number of lines, i.e. the vertical image size.

In accordance with another embodiment, both search range memories P-SRM and S-SRM contain the zero vector access position at each point in time. In other words, the search range memories P-SRM, S-SRM have overlapping address spaces or at least directly adjoining address spaces allowing to test the no-motion hypothesis during motion estimation and allowing the interpolation method to fall back to a standard, i.e. non-motion compensated, interpolation scheme in case no global motion vector can be determined. In other words, according to this embodiment, the vertical line offset vector v_{VLO} is equal to or smaller than the depth of the search range memory.

A frame rate conversion apparatus including the global motion estimator, motion vector estimator and interpolation units as described above allows estimation of interpolated frames containing objects moving along the vertical axis with a velocity that is two times the velocity which can be handled by conventional interpolation units. The length of the compensation range remains the same as for prior art systems and is just shifted by the vertical line offset vector v_{VLO}. However, real life videos rarely contemporaneously contain both upwardly and downwardly moving objects.

In an image processing apparatus, existing modules like the motion vector estimation unit and the interpolation unit have to be adapted only slightly. The additional global motion estimator unit may be a software routine executed by a control unit controlling the motion vector estimation and/or the interpolation unit or an electronic circuit realized in an ASIC (application specific integrated circuit) or a combination thereof and requires only few system resources. Therefore the embodiments of the invention provide a simple and cost-efficient solution for improving the perception quality of a video stream after frame rate conversion or the efficiency of image data compression or the quality of automatic video analysis, by way of example.

In accordance with an embodiment, the first temporal distance between the first and second picture is greater than the second temporal distance between the first or second picture and the third picture generated by interpolation, such that the image processing apparatus converts a first frame rate descriptive for the first temporal distance in a higher, second frame rate descriptive for the second temporal distance.

The image processing apparatus may comprise an interface configured to receive a video stream comprising the first and second image data. The image processing apparatus may be a frame rate converter integrated in a consumer electronic device, for example a television set, a video camera, a cellular phone comprising a video camera functionality, a computer, a television broadcast receiver or an adapter which may be configured to be plugged into a video signal output or input socket. In accordance with other embodiments, the image processing apparatus includes an image pick-up unit configured to capture a video stream containing the first and second pictures in the first temporal distance to each other and to store the first and second image data descriptive for the first and second picture in the first and second picture memories respectively.

Embodiments described in the following refer to details of a global motion estimator unit capable of determining a global motion vector which is descriptive for sign and amount of a global displacement of at least two image portions that move with respect to one first axis both when the image portions move at the same and when they move at different velocities. The moving image portions correspond to predefined windows or picture sections of a frame and the velocity assigned to the respective picture section results from a comparison of corresponding pixel values in corresponding picture sections of two successive frames. In substance, the sums of pixel values of corresponding lines or columns in corresponding picture sections of two successive frames may be compared with each other to determine a parameter characterizing a velocity within a picture section. The velocities are not assigned to objects but characterize the sum of movements within one of the picture sections respectively.

The global motion estimator unit in substance detects when a vertical motion present in the captured pictures is sufficiently uniform, for example for allowing to apply an address offset for picture memory access and, if so, to determine a useful value for the address offset. A global motion estimator unit as described in the following may be used in the context of frame rate conversion as described above. According to other embodiments the global motion estimator unit may be used in an image processing unit used for video analyzing that includes determination and classification of moving objects, for example within the framework of surveillance tasks and monitoring systems, for image coding or for image data compression.

FIG. 7 refers to an image processing device 100 comprising a global motion estimator 110 which receives sequences of image data, each image data being descriptive for a picture (frame) of a video stream SI. A profile generator unit 112 generates for each picture data at least two one-dimensional profiles referring to different picture sections, wherein each one-dimensional profile includes one profile value for each picture line or each picture column extending along a second axis. In accordance with an embodiment, the first axis is the vertical and the second axis the horizontal axis. In accordance with other embodiments, the first axis is the horizontal and the second axis the vertical axis. The choice of the first and second axes typically depends on the internal organization of the hardware, for example on how the cache memories are loaded.

FIG. 9A refers to the generation of line profiles P₁(y), P₂(y). According to the example on the left hand side, a previous frame 902 contains a moving object 911 that moves from a first position 910 along the horizontal axis. The right hand side of FIG. 9A shows the subsequent frame 912 where the moving object 911 has reached the second position 912. The line profiles P₁(y), P₂(y), may result, for example, from summing up all pixel values in one line. At least in the case of homogeneous background, the line profiles P₁(y) and P₂(y) are approximately identical. According to other embodiments, a transformation may be applied to the sum profile, and the transformed sum profile, e.g. a discrete derivative thereof, may be used for further processing.

FIG. 9B refers to a vertical motion. On the left hand side of FIG. 9B the preceding frame 942 shows an object 951 moving along the y-axis from the first position 950 to the second position 952. The third line profile P₁(y) shows a specific characteristic assigned to the moving object 951 in the lines corresponding to the first position 950. The right hand side of FIG. 9B shows a subsequent frame 962 were the moving object 951 has reached the second position 952. In the forth line profile, a specific pattern assigned to the moving object 951 appears at line numbers corresponding to the second position 952. The generated line profiles allow filtering of vertical motions with respect to horizontal motions. The line profiles P₁(y) to P₄(y) as depicted in FIGS. 9A and 9B are for the purpose of illustration only. Typically, the line profiles do not have a maximum value at the position corresponding to a moving object.

Referring again to FIG. 7, the profile generator unit 112 condenses the two-dimensional vector information into a set of one-dimensional vectors. Horizontal motion in the input images will not impact the shape of the line profiles whereas large area vertical motion has noticeable impact. In addition, the profile generator unit 112 generates for each image at least two different profiles, wherein each of them is formed of only a portion of the total image area and wherein each profile covers another area.

FIG. 10A shows an image area 980 which is divided into four sections 990. For each section 990 a line profile is generated. The four sections 990 may cover the complete image area 980. In accordance with an embodiment, the four sections do not cover bar areas 992 at the lower and upper edge of the image area 980 such that black bars in letter-box content, which, for example, occurs with 2.21:1 content presented in a 16:9 coded frame do not impair motion measurements. The vertical size of the excluded areas 992 may be selected such that the largest possible black bars resulting from the discrepancy between content aspect ratio and image frame aspect ratio are excluded from the line profile generation and that valid line profiles are generated for both letter-box and full frame content.

FIG. 10B refers to an embodiment providing nine sections 990, wherein some sections overlap with each other. The sections 990 may be defined such that horizontal and vertical neighboring sections have about 20 to 80%, for example 50% area overlap. In accordance with some embodiments, all sections 990 have identical horizontal dimensions and identical vertical dimensions so that the resulting profiles are comparable regarding profile size and profile values. Selecting a plurality of different profiles of different but overlapping image area sections makes the generation of line profiles more robust against multiple large area motion.

FIG. 10C refers to embodiments, where the image 982 is divided into sections that overlap in one overlap direction only. The overlap direction may be the horizontal one. In accordance with the illustrated embodiment, the overlap direction is the vertical one such that each section 990 overlaps with sections 990 adjacent in vertical direction and not with sections adjacent in horizontal direction. The number of the sections may be a multiple of three, for example nine or twelve.

Referring again to FIG. 7, the profile generator unit 112 outputs for each image a profile matrix S_{P} containing a number N of profile vectors having the same length. N is at least two and typically less than twenty in order to keep the complexity of the profile generator low. In accordance with an embodiment, N is between three and twelve. The profile matrix of a previous or first image S_{P,prev} may be temporarily buffered in a profile matrix storage unit 114 until the profile generator unit 112 has generated the profile matrix S_{P,succ} for the next image. A profile matching unit 116 may receive the profile matrices S_{P,succ} of the second image data and, from the profile matrix storage unit 114, the storage matrix S_{P,prev} from the first image data. The profile matching unit 116 compares previous and successive line profiles individually to determine a dominant vertical shift for each image area section 990 as described above with reference to FIGS. 10A and 10B.

According to an embodiment, the profile matching unit 116 generates, for each pair of corresponding first and second line profiles, a shift value descriptive for a first displacement between the profiles. The first displacement is defined as that displacement of the second profile with respect to the first profile where a predefined central section of the second profile matches best with an arbitrary section of the second profile. This is described in more detail with regard to FIG. 11.

FIG. 11 schematically shows a first profile matrix 995 assigned to a previous first image and a second profile matrix 997 assigned to a second, subsequent image. Each profile matrix 995, 997 contains N line profiles, wherein each line profile has a length H. The profile matching unit compares each pair of corresponding line profiles, for example a first line profile of the first profile matrix 995 and a corresponding first line profile of the second profile matrix 997. A centre region of a height h is defined in each line profile of the second profile matrix 997. A region of the same height is defined in the first line profile of the first profile matrix 995. The first line profile is shifted through all positions of the search range defined from −r to +r, and for each shift position the central region h of the first line profile of the second profile matrix 997 is compared against the corresponding region in the shifted first line profile of the first profile matrix 995. The profile search range may be greater than or equal to 2vₘₐₓ such that the matching process can be improved for true vertical motion beyond 2vₘₐₓ. In each shift position of the first line profile at the first profile matrix 995 a match area is computed and the shift position with the minimum residual match error is recorded and output as a shift value S_{mv,Y}. The procedure is repeated for all pairs of line profiles, such that the profile matching unit 116 outputs for each time instance a vector of shift values S_{mv,Y} having a length corresponding to the number of line profiles. The matching criterion for determining the shift position with minimum residual match error may be the sum of square differences. In accordance with other embodiments, a normalized cross correlation can be employed, depending on application and content type. In accordance with an embodiment, the matching criterion is the sum of absolute difference.

Referring again back to FIG. 7, the vector of shift values S_{mv,Y} is transferred to a calculator unit 118 which determines the global motion vector and/or a vertical line offset on the basis of the shift value vector S_{mv,Y}. The calculator unit 118 may comprise a transform filter unit. From the shift values, the transform filter unit may generate filtered shift values, wherein outlier shift values are attenuated with respect to non-outlier shift values. The calculator unit 118 may determine the global motion vector on the basis of the filtered or the unfiltered shift values.

In accordance with other embodiments, the calculator unit 118 may derive an application specific value from the global motion vector or directly from the filtered or the unfiltered shift values. For example, the calculator unit 118 derives an address offset used for loading the contents of picture memories into two cache memories.

FIG. 8 refers to an embodiment of a calculator unit 118 deriving from the filtered shift values S_{mv,Y} address offsets S_{VLO}, wherein N different shift values are individually filtered by a one-tap IIR (infinite impulse response) filter before one single value is selected as a global vector which represents the estimated dominant vertical motion in the whole image frame. The calculator unit 118 may rely on a plurality of coefficient multipliers. In accordance with an embodiment, the calculator unit 118 includes only one single coefficient multiplier. In accordance with another embodiment, the calculator unit 118 includes an AFC (adapted filter coefficient) unit 810 for adaptively computing a filter coefficient α of a one-tap IIR filter from the variance of the N shift values S_{mv,Y}. The same filter coefficient α may be used for all N parallel filter instances. The coefficient is determined for each time step as

$$α = {α}_{m i n} + {α}_{scale} \cdot min ( 1 , \frac{\sqrt{var ( {S}_{mv , Y} )}}{{σ}_{ma x}} )$$

where αₘᵢₙ and α_{scale} have to be chosen such that α is always in the range between 0 and 1.

The filter effect is weak for low values of coefficient α and strong for high values. The parameter σₘₐₓ determines for which standard deviation of the window measurements in signal S_{mv,Y} the maximum filter effect will be achieved. The beneficial property of this filter is its flexible response to shift values of different reliability.

For example, when the same similar vertical motion is measured in all N image sections 990 of FIGS. 10A and 10B, then the variance of the measurements will be very low or zero and the filter coefficient will be close to αₘᵢₙ. In this case, the filter effect will be weak and the filter output signal S_{mv,Y} will closely follow the filter input signal S_{mv,Y}.

Otherwise, when there is divergent vertical motion across the image sections 990, then the variance of the shift values will be high and the filter coefficient will be close to αₘᵢₙ+α_{scale}. The filter effect will be strong and the filter output signal S_{mv,Y} will follow the filter input signal S_{mv,Y} only slowly and with delay such that the measurement results are smoothed or even discarded.

The IIR filter 801 outputs a vector of filtered window measurements S_{fmv,Y}. Using a selection process a selection unit 830 may derive a global vertical motion signal S_{gm,Y} from the filtered shift values. According to a first embodiment, the selection unit 830 takes the medium value of the N filtered shift values as global vertical motion vector. According to another embodiment, the selector unit 830 discards the lower and upper quartile of the N filter shift values and takes the average of the remaining values as global motion vector S_{gm,Y}. According to further embodiments, the selection unit 830 evaluates the global motion vector S_{gm,Y} from a combination of a rank order filter and a FIR (finite impulse response) filter. The global motion vector S_{gm,Y} represents an estimation for the global vertical motion between previous and subsequent input images.

In accordance with an embodiment, the global motion vector may be finally converted by an offset transformation process in order to generate a vertical line offset signal S_{VLO}. The offset transformation process may comprise a coring operation followed by a clipping operation, wherein a value range of [−r, +r] of the global motion vector is mapped to a value range [−vₘₐₓ, vₘₐₓ] ofl a signal V_{SLO} representing an address offset for loading the contents of a picture memory into a cache memory. An offset transformation unit 840 may perform the offset transformation process using a mapping function describing the relationship between the global motion vector and the address offset. The mapping function may be a continuous function, for example a monotonic or strictly monotonic continuous function.

FIG. 12A refers to an embodiment of the offset transformation process performed by an offset transformation unit 840 as illustrated in FIG. 8, where the mapping function 890 is linear in sections. In accordance with the illustrated embodiment, the offset transformation unit 840 maps small global motion vectors S_{gm,Y} to a zero address offset. In other words, for small global motion vectors, no address offset is applied when the picture memory contents are loaded into cache memories, such that the image processing device performs conventional motion compensation. Above a lower threshold vₙ₁ the address offset may change linearly with the estimated vertical motion until the output value reaches the maximum value vₘₐₓ allowable for a system without global motion vector processing at an upper threshold v₂. Global motion vectors S_{gm,Y} exceeding the upper threshold v₂ are all mapped to the same maximum value vₘₐₓ. In accordance with an embodiment, the lower threshold is at vₘₐₓ/2. For negative global motion vectors, the mapping may be performed accordingly.

FIG. 12B refers to another embodiment, where the mapping function 891 is a continuously differentiable function. The gradient of the mapping function 891 may be low for small global motion vectors and for global motion vectors exceeding the upper threshold v₂. The gradient of the mapping function 891 may be high in the vicinity of the maximum value vₘₐₓ.

FIG. 13 refers to an image processing method. From first and second image data descriptive for first and second images captured in a first temporal distance to each other, a global motion vector is determined which is descriptive for a global displacement of image portions that move with respect to a first axis both when the image portions move at the same speed and when they move at different velocities in relation to non-moving image portions in the first and second images along a first axis (302). Then a further image processing may follow (304). For example, on the basis of the global motion vector and the first and second image data, a motion vector field may be determined which describes a local displacement for each image portion along the first axis and the second axis perpendicular to the first axis.

Determining the motion vector field may include loading a first subset of the first image data from a first picture memory into a first cache memory and loading a second subset of the second image data from a second picture memory into a second cache memory, wherein the cache memories have a faster random access time than the picture memories and the first and second subset represent pixels displaced to each other along the first axis by an offset derived from the global motion vector.

The method may be a frame rate conversion method that further includes generating third image data descriptive for a third image, wherein a pixel value of a third pixel of the third image is obtained by filtering pixel values of at least one first pixel of the first image data and pixel values of at least one second pixel of the second image data, wherein the first and second pixels are identified by a position of the third pixel, at least one entry in the motion vector field associated to the third pixel, the global motion vector and a ratio between the first temporal distance and a second temporal distance between the first and third images.

Generating the third image data may further include loading a third subset of the first image data from the first picture memory into a third cache memory and loading a fourth subset of the second image data from the second picture memory into a fourth cache memory, where the cache memories have a faster random access time than the picture memories and an address offset derived from the global motion vector is applied to read addresses of one of the first and second picture memories.

The first temporal distance may be greater than the second temporal distance such that the method provides a frame rate conversion converting a first frame rate descriptive for the first temporal distance in a higher, second frame rate descriptive for the second temporal distance.

FIG. 14 refers to an image processing method that includes estimation of a global motion vector. For each of a first and second picture data at least a first line profile for a first picture section and a second line profile for another picture section is generated, wherein each line profile includes a profile value for picture lines extending along the second axis (312). On the basis of comparisons of the first and second line profiles of the first and second picture data, the global motion vector is determined, wherein the obtained global motion vector is descriptive for a global displacement of moving image portions with respect to non-moving image portions in the first and second images along first axis perpendicular to the second axis (314).

The method may further include loading a first subset of the first image data from a first picture memory into a first cache memory and loading a second subset of the second image data from a second picture memory into a second cache memory, the cache memories have a faster random access time than the picture memories and the first and second subset corresponding to pixels displaced to each other along the first axis by an address offset derived from the global motion vector, and to access the cache memories for image processing, and determining the address offset from the global motion vector on the basis of the shift values, wherein a value range of the global motion vector is mapped to the value range of the address offset, and for each sign, small amounts of the global motion vector below a lower threshold are mapped to a zero address offset, high values of the global motion vector above a higher threshold are mapped to the maximum address offset and between the lower and the higher threshold the address offset changes linearly with the increasing global motion vector.

1. An image processing apparatus comprising
a global motion estimator unit (110) configured to determine, from first and second image data descriptive for a first and second picture captured in a first temporal distance to each other, a global motion vector descriptive for sign and amount of a global displacement of at least two image portions with respect to a first axis both when the image portions move at the same velocity and when they move at different velocities.

2. The image processing apparatus of claim 1, wherein
the moving image portions correspond to predefined picture sections of the first and second pictures and a velocity assigned to the respective picture section results from a comparison of corresponding pixel values in corresponding picture sections of the first and sec- and pictures.

3. The image processing apparatus of claim 1, further comprising
a motion vector estimator unit (140) configured to determine, from the global motion vector and the first and second image data a motion vector field describing a local displacement for each image portion along the first axis and a second axis perpendicular to the first axis.

4. The image processing apparatus of claim 3, wherein
the motion vector estimator unit (140) is further configured to load a first subset of the first image data from a first picture memory (121) into a first cache memory (122) and to load a second subset of the second image data from a second picture memory (131) into a second cache memory (132), the cache memories (122, 132) have a faster random access time than the picture memories (121, 131) and the first and second subset corresponding to pixels displaced to each other along the first axis by a displacement derived from the global motion vector, and to access the cache memories (122, 132) for determining the motion vector field.

5. The image processing apparatus of claim 1, further comprising
an interpolation unit (171) configured to generate third image data descriptive for a third image, wherein a pixel value of a third pixel of the third image is obtained by filtering pixel values of at least one first pixel of the first image data and pixel values of at least one second pixel of the second image data, wherein the first and second pixels are identified by a position of the third pixel, at least one entry in the motion vector field associated to the third pixel, the global motion vector and a ratio between the first temporal distance and a second temporal distance between the first and third pictures.

6. The image processing apparatus of claim 5, wherein
the interpolation unit (171) is further configured to load a third subset of the first image data from the third picture memory (151) into a third cache memory (152) and to load a fourth subset of the second image data from the fourth picture memory (161) into a fourth cache memory (162), the cache memories (152, 162) having a faster random access time than the picture memories (151, 161), wherein an address offset derived from the global motion vector is applied to read addresses of one of the third and fourth picture memories (151, 161), and to access the cache memories (152, 162) for generating the third image data.

7. The image processing apparatus of claim 5, wherein
the first temporal distance is greater than the second temporal distance such that the image processing apparatus (100) is configured to convert a first frame rate descriptive for the first temporal distance in a higher, second frame rate descriptive for the second temporal distance.

8. The image processing apparatus of claim 1, wherein
the global motion estimator unit (110) comprises a profile generator unit (112) configured to generate, for each of the first and second picture data, at least a first line profile for a first picture section and a second line profile for another picture section, each line profile including a profile value for picture lines extending along the second axis, and
the global motion estimator unit (110) is further configured to determine the global motion vector on the basis of comparisons of the first and second line profiles respectively.

9. The image processing apparatus of claim 8, wherein
the global motion estimator unit (110) further comprises a profile matching unit (116) configured to generate, for each pair of corresponding first and second line profiles, a shift value descriptive for a first displacement between the line profiles, wherein the first displacement is defined as that displacement of the second line profile with respect to the first line profile where a predefined central section of the second line profile matches best with an arbitrary section of the first line profile and
a calculator unit (118) configured to determine the global motion vector on the basis of the shift values.

10. The image processing apparatus of claim 8, wherein
the calculator unit (118) comprises a transform filter unit (801) configured to generate, from the shift values, filtered shift values, wherein outlier shift values are attenuated with respect to non-outlier shift value and
the calculator unit (118) is configured to determine the global motion vector on the basis of the filtered shift values.

11. The image processing apparatus of claim 9, further comprising
an image processing unit (100) configured to load a first subset of the first image data from a first picture memory (121, 151) into a first cache memory (132, 152) and to load a second subset of the second image data from a second picture memory (131, 161) into a second cache memory (132, 162), the cache memories have a faster random access time than the picture memories and the first and second subset corresponding to pixels displaced to each other along the first axis by an address offset derived from the global motion vector, and to access the cache memories for image processing, and
an offset transformation unit (840) configured to determine the address offset from the global motion vector on the basis of the shift values, wherein a mapping function (890, 891) describing the relationship between the global motion vector and the address offset is a monotonic continuous function.

12. A method of operating an image processing apparatus (100), the method comprising
determining, in a global motion estimation unit from first and second image data descriptive for a first and second image captured in a first temporal distance to each other, a global motion vector descriptive for a global displacement of all image portions that move with respect to a first axis both when the image portions move at the same speed and when they move at different velocities in relation to non-moving image portions in the first and second images.

13. The method of claim 12, further comprising
determining, from the global motion vector and the first and second image data a motion vector field describing a local displacement for each image portion along the first axis and a second axis perpendicular to the first axis.

14. The method of claim 12, wherein determining the global motion vector comprises
generating, for each of the first and second picture data, at least a first one-dimensional profile for a first picture section and a second one-dimensional profile for another picture section, each profile including a profile value for picture lines or columns extending along the second axis, and
determining the global motion vector on the basis of comparisons of the first and second profiles respectively.

15. The method of claim 14, wherein determining the global motion vector comprises
generating, for each pair of corresponding first and second profiles, a shift value descriptive for a first displacement between the profiles, wherein the first displacement is defined as that displacement of the second profile with respect to the first profile where a predefined central section of the second profile matches best with an arbitrary section of the first profile, and
generating, from the shift values, filtered shift values, wherein outlier shift values are attenuated with respect to non-outlier shift value and
determining the global motion vector on the basis of the filtered shift values.
